(19) United States
(12) Patent Application Publication
(10) Pub. No.: US 2007/0070384 A1
(43) Pub. Date: Mar. 29, 2007

(54) Ultra-power saving facsimile apparatus and method thereof

(75) Inventor: Cheol-Min Jeon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/495,714

(22) Filed: Jul. 31, 2006

(30) Foreign Application Priority Data
Sep. 27, 2005 (KR) 2005-89914

(51) Int. Cl. G06K 15/00

(52) U.S. Cl. 358/1.14; 358/401

(57) ABSTRACT

An ultra-power saving facsimile apparatus connected a general public switched telephone network (PSTN) and method thereof is provided for maintaining a standby state where less than 1 W of power is consumed using a power-saving circuit if the standby state continues for a certain period, thereby achieving a cost-saving effect. Accordingly, it is possible to realize the ultra-power saving facsimile apparatus that consumes less than 1 watt of power in the standby state and reduces cost by using a low-priced transistor, FET and photo coupler.

### CROSS REFERENCE TO RELATED APPLICATION

This application claims the benefit under 35 U.S.C. §119(a) of Korean Patent Application No. 2005-89914, filed on Sep. 27, 2005, in the Korean Intellectual Property Office, the entire disclosure of which is hereby incorporated by reference.

### BACKGROUND OF THE INVENTION

1. Field of the Invention

The present invention relates to an ultra-power saving facsimile apparatus and method thereof. More particularly, the present invention relates to an ultra-power saving facsimile apparatus and method thereof which is connected to a public switched telephone network (PSTN) and maintains a standby state with a power source less than 1 W using a power-saving circuit if the standby state continues for a certain period, thereby achieving a cost-saving effect.

2. Description of the Related Art

The modern day trend in the electronics industry is a shift towards more environmentally friendly products. Recently, the purchase and use of environmentally friendly products have become increasingly popular in many areas including government and public offices. In order to supply the U.S. government and public offices with goods, a supplier must earn a power-saving mark such as an Energy Star mark. The Energy Star mark serves as an indication that the products meet strict energy-efficiency guidelines set by the US Environmental Protection Agency (EPA) and the US Department of Energy (DOE). This requirement has led many countries including Korea to require ultra-power saving products.

FIG. 1 is a block diagram illustrating a conventional power saving facsimile apparatus.

A conventional power saving facsimile apparatus 100 comprises a ring signal detector 10 to detect a ring signal applied through a telephone line, a switch 20 that is switched on when the ring signal is detected, a facsimile unit 30 that is powered-on by the switch 20 and powered-off after data is received, and a power supply unit 40 to control a power state of the power saving facsimile apparatus 100 and to control the ring signal supplied from the ring signal detector 10.

In order to transmit preferable data using the facsimile unit 30, a user accesses a facsimile of a correspondent user by dialing a fax number of the correspondent user and transmits a ring signal to the facsimile of the correspondent user connected with a public switched telephone network (PSTN).

Upon receiving a ring signal through a telephone line, the ring detector 10 detects the ring signal and the switch 20 is automatically switched on. If the ring signal is not detected, the facsimile unit 30 remains on standby, that is, is powered off.

When the switch 20 is automatically switched on, the facsimile unit 30 is powered-on and is connected to a telephone, thereby enabling data reception. The power supply unit 40 determines whether the data reception is completed. If the data reception is not completed, the power supply unit 40 allows the facsimile unit 30 to continuously receive data. If the data reception is completed, the power supply unit 40 automatically powers off the facsimile unit 30.

The conventional power saving facsimile apparatus 100 operating as described above has a power-saving function such that it consumes power of approximately 40 to 50 watts (W) when receiving data and outputting data, whereas it consumes power of approximately 5 to 10 watts (W) in a standby state where no ring signal is received.

However, the conventional power saving facsimile apparatus 100 does not satisfy the condition for an ultra-power saving function consuming less than 1 watt of power as required by many countries. Some printers have a power save button and satisfy the condition for an ultra-power saving function with a power source of less than 1 watt. However, these printers require an extra low-power integrated circuit to do so. The use of these integrated circuits results in an increase in manufacturing costs.

Accordingly, there is a need for an improved system for providing a power saving facsimile capable of functioning with a power less than 1 watt without an extra low-power integrated circuit.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an ultra-power saving facsimile apparatus which consumes less than 1 watt of power in a standby state using a power-saving circuit when the standby state continues for a predetermined period, thereby achieving a cost-saving effect.

The above aspect is achieved by providing an ultra-power saving facsimile apparatus including a power supply unit that receives AC power from an external source and generates a first DC power necessary to operate the ultra-power saving facsimile apparatus. The ultra-power saving facsimile apparatus also includes a power-saving unit and a controller. The power saving unit switches according to a predetermined power control signal and converts the first DC power into a second power such that the ultra-power saving facsimile apparatus consumes less than 1 watt (W) of power in a standby state. If no operation is performed or there is no key input command for a predetermined time in the standby state, the controller applies the power control signal to the power-saving unit and controls the power-saving unit to output the second power such that the ultra-power saving facsimile apparatus consumes less than 1 W of power in the standby state.

Preferably, the power supply unit comprises an adaptor or a switching mode power supply (SMPS).

Preferably, the power saving unit includes a first switching unit that switches an output voltage of the power supply unit, a second switching unit that switches on/off the first switching unit according to the power control signal of the controller, a third switching unit that switches on/off the first switching unit according to a switching operation of a user, and a fourth switching unit that switches on/off the first switching unit according to a ring signal applied through a telephone line.

Preferably, the first switching unit is a P channel FET that is turned off when no voltage is applied to a gate G and is turned on when the gate G is in a low level state for current to flow from a drain D to a source S.

Preferably, the second switching unit is an NPN-type transistor that is turned on by a high level signal applied from the controller.

Preferably, the NPN-type transistor has an emitter grounded and a collector connected to the first switching unit in parallel through a first resistor and a second resistor which are connected to each other in series.

Preferably, the third switching unit is a push button switch that is switched on by a pushing operation of a user.

Preferably, the third switching unit is connected to the first switching unit in series through a resistor.

Preferably, the fourth switching unit is a photo coupler that combines a light emitting diode and a photo transistor into a single package, and is turned on by emitting light through the light emitting diode in response to the ring signal applied through a telephone line and receiving light through a base of the photo transistor.

Further, the controller is connected with a switching detection node to detect whether the third switching unit is switched on or off, and is also connected with a ring signal detection node to determine whether the ring signal is received based on the switching operation of the fourth switching unit.

Preferably, the switching detection node connects the controller to the third switching unit and is connected to a power supply Vcc in parallel through a resistor and connected to a diode in series to prevent a backflow of a current.

Preferably, when the third switching unit is switched off, the switching detection node is in a high level state by the power supply Vcc, and when the third switching unit is switched on, the switching detection node is in a low level state because the power supply Vcc is applied to the third switching unit, the controller detecting the switching-on operation of the third switching unit based on the conversion from the high level state to the low level state.

Preferably, the ring signal detection node connects the controller to the fourth switching unit and is connected to a power supply Vcc in parallel through a resistor and also connected to a diode in series to prevent a backflow of a current.

Finally, when the fourth switching unit is switched off, the ring signal detection node is in a high level state by the power supply Vcc, and when the fourth switching unit is switched on, the power supply Vcc is applied to the fourth switching unit, the controller detecting a switching-on operation of the fourth switching unit based on the conversion form the high level state to the low level state and thus detecting that the ring signal is received.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram illustrating a conventional power saving facsimile apparatus;

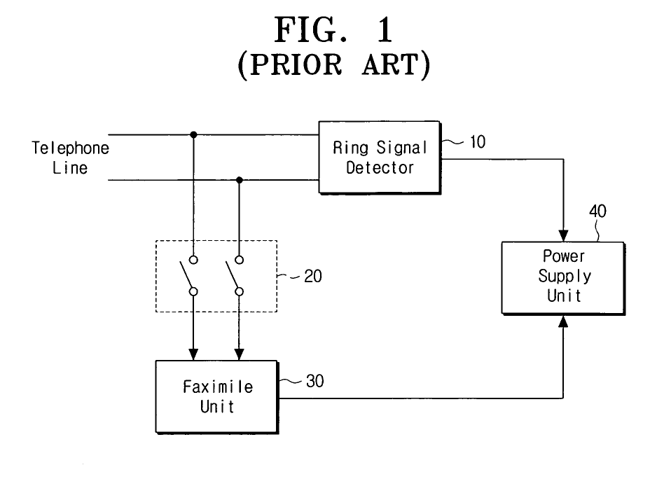

FIG. 2 is a block diagram illustrating an ultra-power saving facsimile apparatus according to an embodiment of the present invention; and

FIG. 3 is a circuit diagram illustrating a power-saving unit of FIG. 2.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

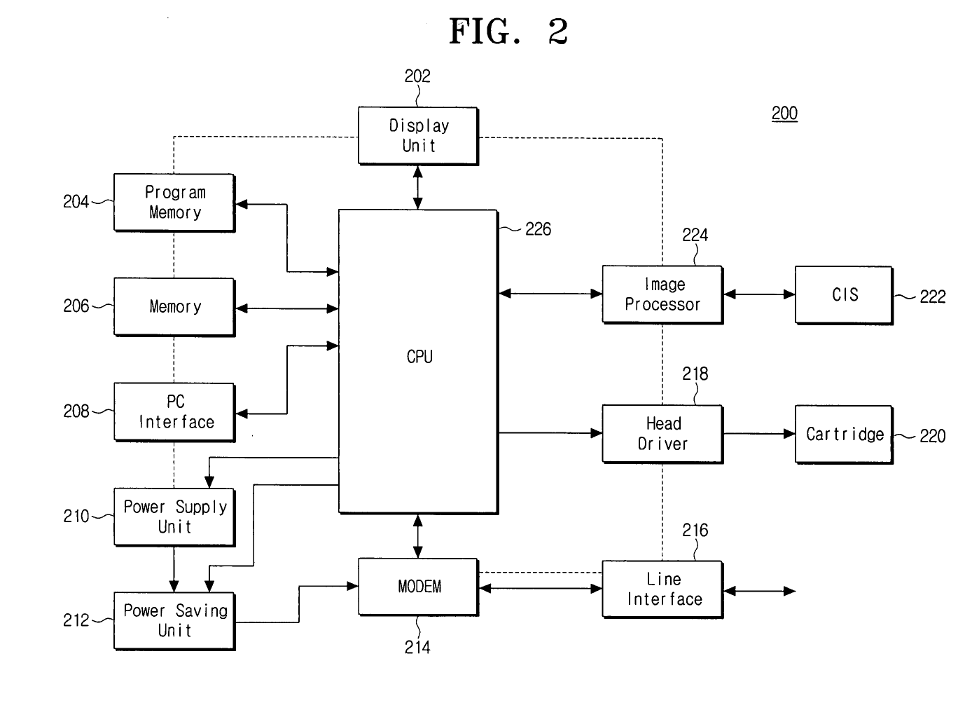

FIG. 2 is a block diagram illustrating an ultra-power saving facsimile apparatus 200 according to an exemplary embodiment of the present invention.

The ultra-power saving facsimile apparatus 200 comprises a display unit 202, a program memory 204, a memory 206, a PC interface 208, a power supply unit 210, a power saving unit 212, a modem 214, a line interface 216, a head driver 218, a cartridge 220, a compact image sensor (CIS) 222, an image processor 224, and a controller (CPU) 226.

The display unit 202 displays an operational status of a plurality of input keys and an operational status of the ultra-power saving facsimile apparatus 200. The program memory 204 stores a program necessary to operate the ultra-power saving facsimile apparatus 200 and also stores a white/black shading value.

The memory 206 temporarily stores a variety of data that is generated during the operation of the ultra-power saving facsimile apparatus 200. The PC interface 208 interfaces between the ultra-power saving facsimile apparatus 200 and a computer and is typically connected with a parallel port of the computer.

The power supply unit 210 receives an AC from an external source and converts the AC power into a first DC power that is necessary to operate the ultra-power saving facsimile apparatus 200. For example, the power supply unit 210 uses an adaptor or a switching mode power supply (SMPS).

The power saving unit 212 switches according to a power control signal of the controller 226 and converts the first DC power into a second power so that the ultra-power saving facsimile apparatus 200 is on standby with a power source of less than 1 watt.

The modem 214 codes/decodes a fax image data, detects a tone, perceives and transmits a facsimile signal (calling (CNG)/called (CED)). The line interface 216 interfaces between a public switched telephone network (PSTN) and the modem 214.

The head driver 218 drives an inkjet cartridge by way of example, and comprises a data transmitter to transmit print data to the cartridge 220 and a nozzle driver to operate nozzles of the cartridge 220 according to the transmitted data.

The cartridge 220 prints an image on a print paper sheet. The cartridge 220 directly jets ink onto the print paper sheet under the control of the head driver 218. The CIS 222 is an assembly part that controls a LED embedded therein to emit lights and reads an image from a document using a light- receiving sensor.

The image processor 224 digitizes analog image data read by the CIS 222 and simultaneously processes the image data by applying the white/black shading value.

The controller 226 controls entire operations of the components according to the program stored in the program memory 204. Especially, if no operation is performed in the ultra-power saving facsimile apparatus 200 or no key command is input in a standby state for a predetermined period. Also, the controller 226 supplies a power control signal to the power-saving unit 210 and controls the power-saving unit 210 to perform the standby operation so that less than 1 watt of power is consumed.

Although the exemplary embodiment of the present invention is applied to a facsimile machine, it is applicable to a multi-function peripheral.

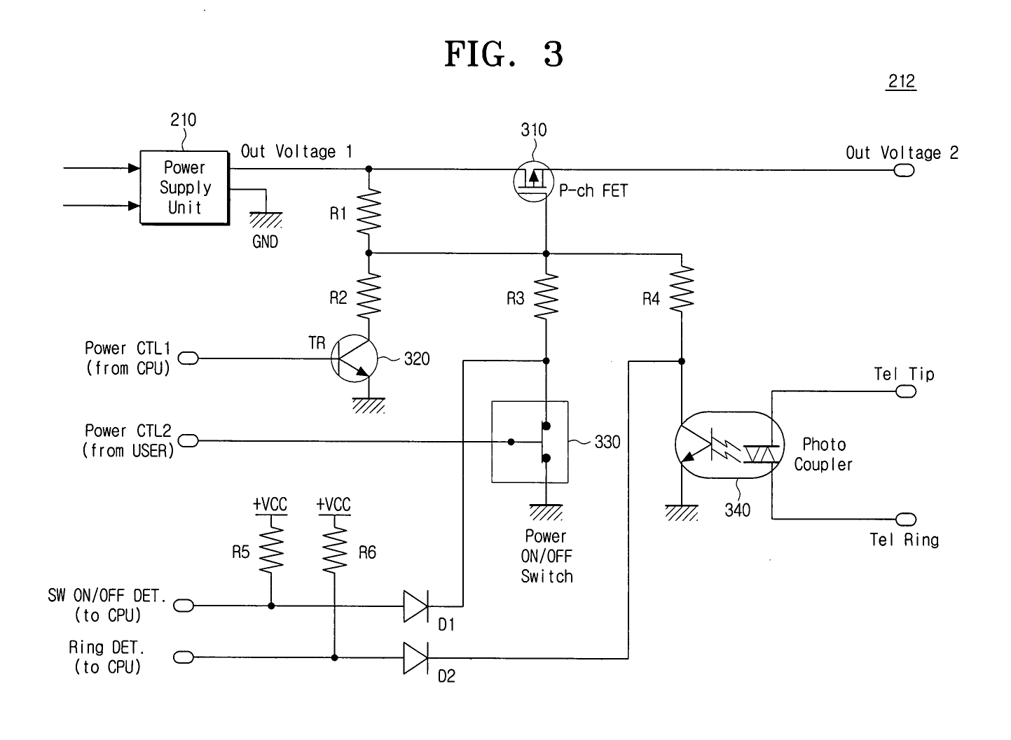

FIG. 3 is a circuit diagram illustrating the power saving unit 212 according to an exemplary embodiment of the present invention.

The power saving unit 212 as shown in FIG. 3 comprises a first switching unit (P-ch FET) 310 to switch a first output voltage of the power supply unit 210, a second switching unit (TR) 320 to switch on/off the first switching unit 310 according to a first power control signal of the controller 226, a third switching unit 330 to switch on/off the first switching unit 310 according to a second power control signal input by a user, and a fourth switching unit 340 to switch on/off the first switching unit 310 according to a ring signal applied through a telephone line.

The first switching unit 310 uses a P channel FET that is turned off when no voltage is applied to a gate G and turned on when the gate G is in a low level state to allow a current to flow from a drain D to a source S.

The second switching unit 320 uses an NPN-type transistor (TR) that is turned on by a high level signal applied from the controller 226, and the third switching unit 330 uses a push button switch that is switched on by a pushing operation of a user. The second switching unit 320 has an emitter grounded and a collector connected to the drain of the first switching unit 310 in parallel through a first resistor RI and a second resistor R2 that are connected to each other in series. The third switching unit 330 is connected to the gate G of the first switching unit 310 in series through a third resistor R3.

The fourth switching unit 340 uses a photo coupler that combines a light emitting diode as a light emitting cell and a photo transistor as a light receiving cell into one package. The fourth switching unit 340 emits light through the light emitting diode according to a ring signal applied through the telephone line and receives light through a base of the photo transistor, thereby being turned on. The fourth switching unit 340 is connected to the gate G of the first switching unit 310 in series through a fourth resistor R4.

The controller 226 is connected with a switching detection node and a ring signal detection node. The switching detection node detects whether the third switching unit 330 is switched on or off and the ring signal detection node determines whether the ring signal is received based on the switching operation of the fourth switching unit 340.

The switching detection node connects the controller 226 to the third switching unit 330. The switching detection node is connected to a power supply Vcc in parallel through a fifth resistor R5 and also connected to a first diode D1 in series to prevent a backflow of current. Accordingly, if the third switching unit 330 is switched off, the switching detection node is in a high level state by the power supply Vcc, and if the third switching unit 330 is switched on, the switching detection node is in a low level state because the power supply VCC is applied to a ground GND through the third switching unit 330. The controller 226 detects the switching operation of the third switching unit 330 based on the conversion of the switching detection node from the high level state into the low level state.

The ring signal detection node connects the controller 226 to the fourth switching unit 340. The ring signal detection node is connected to a power supply Vcc in parallel through a sixth resistor R6 and also connected to a second diode D2 in series to prevent a backflow of current. Accordingly, if the fourth switching unit 340 is switched off, the ring signal detection node is in a high level state by the power supply Vcc, and if the fourth switching unit 340 is switched on, the ring signal detection node is in a low level state because the power supply Vcc is applied to the ground GND through the fourth switching unit 340. The controller 226 detects the conversion from the high level state to the low level state and determines whether the ring signal is received based on the switching operation of the fourth switching unit 340.

The operation of the ultra-power saving facsimile apparatus 200 described above will now be discussed in more detail.

When AC power is input into the power supply unit 210, a first output voltage is generated. However, a second output voltage to be applied to the controller 226 and the memory 206 is not generated because the P-channel FET of the first switching unit 310 does not operate, so that the ultra-power saving facsimile apparatus 200 is idle.

At this time, the second switching unit 320 is switched off because there is no control signal applied from the controller 226, the third switching unit 330 is switched off because there is no pushing operation, and the fourth switching unit 340 is switched off because there is no ring signal as input.

When a user pushes the third switching unit 330 for more than approximately 300 msec, voltages divided from the first output voltage by the first and the third resistors R1 and R3 are applied to the ground GND through the third switching unit 330, and accordingly, the gate of the first switching unit 310 is in a low level state. Therefore, the first switching unit 310 is turned on and thereby generates a second output voltage.

The second output voltage operates the controller 226, and the controller 226 applies a high level first power control signal to the second switching unit 320. The second switching unit 320 is switched on according to the high level first power control signal applied from the controller 226, and the first output voltage is applied to the second switching unit 320 through the first and the second resistors R1 and R2 according to the switching-on operation of the second switching unit 320. Accordingly, the first switching unit 310 and the second switching unit 320 continue to apply the voltage to the ultra-power saving facsimile apparatus 100.

Therefore, in order to turn off the ultra-power saving facsimile apparatus 100, a user pushes the third switching unit 330. At this time, the controller 226 detects the switch push/pull of the third switching unit 330 by using the switching detection node. The switching detection node is in a high level state by the power supply Vcc when the third switching unit 330 is switched off at usual time, and is in a low level state when the third switching unit 330 is switched on because the power supply Vcc is applied to the ground through the third switching unit 330. The controller 226 detects the conversion from the high level state to the low level state and thereby perceives the switch push/pull of the third switching unit 330.

The first diode D1 allows the power supply Vcc to flow toward the third switching unit 330 in a forward direction, and at usual time. The first diode D1 does not allow the voltage of the first and the third resistors R1 and R3 to flow toward the controller 226.

Meanwhile, if no operation is performed or no key command is input for a predetermined period after the ultra-power saving facsimile apparatus 100 completes a job such as facsimile receipt or copy, the controller 226 calculates times according to a pre-defined program till the ultra-power saving facsimile apparatus 100 performs a next job. For example, if no operation is performed or no key command is input for 30 minutes which is a standard time of the EPA, the controller 226 applies a low level first power control signal to the second switching unit 320.

The second switching unit 320 is switched off by the low level power control signal applied to a base thereof. When the second switching unit 320 is switched off, the gate of the first switching unit 310 is in a high state and thus is turned off. Accordingly, the second output voltage is interrupted according to the switching operation of the first switching unit 310. At this time, the ultra-power saving facsimile apparatus 100 saves up to approximately 700 nW (0.7 W) according to an efficiency of an adaptor or SMPS of the power supply unit 210.

When a ring signal is input through the telephone line from the outside in a power-saving mode consuming less than 1 watt of power as described above, the fourth switching unit 340 is switched on by the ring signal inputted through a telephone line.

The photo coupler for the fourth switching unit 340 operates for a ring period (typically 1 sec) and converts the high level voltage applied to the first and the fourth resistors R1 and R4 into a low level signal. Accordingly, the first switching unit 310 is switched on and the second output voltage is generated so that the ultra-power saving facsimile apparatus 100 is operated.

As described above, it is possible to realize the ultra-power saving facsimile apparatus 100 that consumes less than 1 watt of power less in the standby state and reduces cost by using a low-priced transistor, FET and photo coupler.

While the invention has been shown and described with reference to certain exemplary embodiments thereof, it will be understood by those skilled in the art that various changes in form and details may be made therein without departing from the spirit and the scope of the invention as defined by the appended claims.

What is claimed is:

1. An ultra-power saving facsimile apparatus comprising:
a power supply unit for receiving an AC power from an external source and for generating a first DC power that is necessary to operate the ultra-power saving facsimile apparatus;
a power-saving unit for switching according to a power control signal and for converting the first DC power into a second power such that the ultra-power saving facsimile apparatus consumes less than 1 watt (W) of power in a standby state; and
a controller for applying the power control signal to the power-saving unit when no operation is performed or there is no key input command for a predetermined time in the standby state, and for controlling the power-saving unit to output the second power such that the ultra-power saving facsimile apparatus is in the standby state with a power less than 1 W.

2. The ultra-power saving facsimile apparatus as claimed in claim 1, wherein the power supply unit comprises at least one of an adaptor and a switching mode power supply (SMPS).

3. The ultra-power saving facsimile apparatus as claimed in claim 1, wherein the power saving unit comprises:
a first switching unit for switching an output voltage of the power supply unit;
a second switching unit for switching on/off the first switching unit according to the power control signal of the controller;
a third switching unit for switching on/off the first switching unit according to a switching operation of a user; and
a fourth switching unit for switching on/off the first switching unit according to a ring signal applied through a telephone line.

4. The ultra-power saving facsimile apparatus as claimed in claim 3, wherein the first switching unit is a P channel FET that is turned off when no voltage is applied to a gate G and is turned on when the gate G is in a low level state for current to flow from a drain D to a source S.

5. The ultra-power saving facsimile apparatus as claimed in claim 3, wherein the second switching unit is an NPN-type transistor that is turned on by a high level signal applied from the controller.

6. The ultra-power saving facsimile apparatus as claimed in claim 5, wherein the NPN-type transistor has an emitter grounded and a collector connected to the first switching unit in parallel through a first resistor and a second resistor which are connected to each other in series.

7. The ultra-power saving facsimile apparatus as claimed in claim 3, wherein the third switching unit is a push button switch that is switched on by a pushing operation of a user.

8. The ultra-power saving facsimile apparatus as claimed in claim 7, wherein the third switching unit is connected to the first switching unit in series through a resistor.

9. The ultra-power saving facsimile apparatus as claimed in claim 3, wherein the fourth switching unit is a photo coupler for combining a light emitting diode and a photo transistor into a single package, and is turned on by emitting light through the light emitting diode in response to the ring signal applied through a telephone line and for receiving light through a base of the photo transistor.

10. The ultra-power saving facsimile apparatus as claimed in claim 3, wherein the controller is connected with a switching detection node for detecting whether the third switching unit is switched on or off, and is also connected with a ring signal detection node for determining whether the ring signal is received based on the switching operation of the fourth switching unit.

11. The ultra-power saving facsimile apparatus as claimed in claim 10, wherein the switching detection node connects the controller to the third switching unit and is connected to a power supply Vcc in parallel through a resistor and connected to a diode in series to prevent a backflow of a current.

12. The ultra-power saving facsimile apparatus as claimed in claim 11, wherein when the third switching unit is switched off, the switching detection node is in a high level state by the power supply Vcc, and when the third switching unit is switched on, the switching detection node is in a low level state because the power supply Vcc is applied to the third switching unit, the controller detecting the switching-on operation of the third switching unit based on the conversion from the high level state to the low level state.

13. The ultra-power saving facsimile apparatus as claimed in claim 10, wherein the ring signal detection node connects the controller to the fourth switching unit and is connected to a power supply Vcc in parallel through a resistor and also connected to a diode in series to prevent a backflow of a current.

14. The ultra-power saving facsimile apparatus as claimed in claim 13, wherein the ring signal detection node is in a high level state by the power supply Vcc when the fourth switching unit is switched off, and the power supply Vcc is applied to the fourth switching unit when the fourth switching unit is switched on, the controller detecting a switching-on operation of the fourth switching unit based on the conversion from the high level state to the low level state and thus detecting that the ring signal is received.

15. A method for saving power, the method comprising:
receiving an AC power from an external source;
generating a first DC power to operate an ultra-power saving facsimile apparatus in a power supply unit;
switching and converting, according to a power control signal, the first DC power into a second power whereby the ultra-power saving facsimile apparatus consumes less than 1 watt (W) of power in a standby state in a power saving unit;
applying the power control signal to the power-saving unit when no operation is performed or there is no key input command for a predetermined time in the standby state and for controlling the power-saving unit to output the second power such that the ultra-power saving facsimile apparatus is in the standby state with a power less than 1 W.

16. The method of claim 15, wherein the power saving method further comprising:
switching an output voltage of the power supply unit;
switching on/off a first switching unit according to the power control signal of the controller;
switching on/off the first switching unit according to a switching operation of a user; and
switching on/off the first switching unit according to a ring signal applied through a telephone line.
